(19) United States
(12) Patent Application Publication
(10) Pub. No.: US 2017/0368920 A1
(43) Pub. Date: Dec. 28, 2017

(54) SIDE SHIELD ARRANGEMENT AND OPENABLE ROOF SYSTEM OF AN AUTOMOTIVE VEHICLE

(71) Applicants: Hartmut EBERST, Schwaebisch Gmuend (DE); Rainer ARNOLD, Schotten (DE)

(72) Inventors: Hartmut EBERST, Schwaebisch Gmuend (DE); Rainer ARNOLD, Schotten (DE)

(21) Appl. No.: 15/632,734

(22) Filed: Jun. 26, 2017

(30) Foreign Application Priority Data
Jun. 27, 2016 (DE) 10 2016 211 537.5

(51) Int. Cl. B60J 7/043

(52) U.S. Cl. CPC B60J 7/043

(57) ABSTRACT

A side shield arrangement for an openable roof system of an automotive vehicle, comprising a shield blade which is mounted to be pivotable between a lowered rest position and a deployed functional position, which has two bearing points spaced from each other in the longitudinal direction of the shield blade, and which has force applied by a spring device towards the direction of the deployed functional position, is known.

According to the invention, a front bearing point is disposed on the face end of the shield blade, and a rear bearing point is provided with the spring device.

### CROSS-REFERENCE TO RELATED APPLICATIONS

This claims priority from German Patent Application No. DE 10 2016 211 537.5, filed on Jun. 27, 2016, the disclosure of which is hereby incorporated by reference in its entirety.

### FIELD OF THE INVENTION

The invention relates to a side shield arrangement for an openable roof system of an automotive vehicle, comprising a shield blade which is mounted to be pivotable between a lowered rest position and a deployed functional position, which has two bearing points spaced from each other in the longitudinal direction of the shield blade, and which has force applied by a spring device towards the direction of the deployed functional position.

The invention also relates to an openable roof system of an automotive vehicle, comprising a roof part displaceable between a closed position and an open position, and comprising at least one such side shield arrangement.

### BACKGROUND OF THE INVENTION

Such a side shield arrangement is disclosed in DE 10 2011 119 991 B3. Said side shield arrangement extends laterally along a roof opening portion of a vehicle roof, which roof opening portion is exposable or closable by a movable roof part. Said side shield arrangement is pivotably mounted by means of a pivot bearing in a roof-fixed guiding rail region for the movable roof part. The pivot bearing includes a curved or arched pivot axis. Said side shield arrangement is assembled from a plurality of shield sections adjoining in the longitudinal direction.

### SUMMARY OF THE INVENTION

It is the object of the invention to provide a side shield arrangement of the type mentioned at the beginning which occupies a small amount of construction space.

This object is achieved in that a front bearing point is disposed on the face end of the shield blade, and in that a rear bearing point is provided with the spring device. Owing to the face end-sided bearing of the shield blade in the region of the front bearing point, a particularly space efficient and yet functionally reliable bearing is obtained. The face end-sided arrangement of the front bearing point, moreover, results in reduced bending moments on the shield blade. Owing to the face end-sided front bearing, it is sufficient to provide merely the rear bearing point with the spring device. Preferably, the spring device has a mechanical configuration. Advantageously, the front and the rear bearing points are oriented in relation to each other in such a manner that they define a common, unique straight-linear pivot axis for the shield blade. The spring device acts towards the deployment direction of the shield blade.

In an embodiment of the invention, the shield blade is provided with a reinforcement in the region of the rear bearing point. The reinforcement can be integrally shaped in the shield blade. As an alternative, the reinforcement can be at least one separately produced reinforcing section applied to the shield blade. If the reinforcement is in one piece integrated in the shield blade, the shield blade is preferably made of synthetic material in the type of a plate and has at least one bead or bulge acting as reinforcement.

In a further embodiment of the invention, both the front and the rear bearing points have a roof-fixed bearing section, each thereof adhesively bonded to a supporting surface of the roof system in the ready-for-use assembled condition. The respective bearing sections of the two bearing points of the shield blade are preferably embodied in a flat, plate-type bearing flange which is adhesively bonded to the supporting surface of the roof system by means of a liquid adhesive, by means of a double-sided adhesive tape, by means of a hot-melt adhesive or by similar ways and means. The supporting surface of the roof system provided is preferably a profiled surface section of a guiding rail system, used for displacing the movable roof part, and disposed laterally adjacent to the roof opening portion which can be closed by the movable roof part.

In a further embodiment of the invention, the spring device includes a leg spring which is supported on the shield blade in the region of the reinforcement. Owing to this embodiment, a particularly good permanent torque transmission of the spring forces of the leg spring to the shield blade is achievable. Preferably, the leg spring has a bow-shaped leg, which is supported on the shield blade in the region of the reinforcement, and with its opposite leg ends passes into two mutually coaxial helical coil regions of the leg spring. Corresponding ends of the helical coil regions are respectively supported on the roof-fixed bearing section of the rear bearing point.

Another object of the invention is to provide an openable roof system of the type mentioned at the beginning which offers good sight protection and noise protection in the side areas of the displaceable roof part.

For the openable roof system, the object of the invention is achieved in that the roof part includes at least one sealing profile in the region of a bottom side, which sealing profile cooperates with the side shield arrangement during an opening or closing move of the roof part.

The sealing profile is preferably designed in the type of a ridge or a strip and protrudes from the bottom side of the roof part downwards. Preferably, each side shield arrangement is associated with a respective corresponding sealing profile so that with two side shield arrangements in the region of opposite longitudinal sides of the roof system the roof part is associated with two downwards protruding sealing profiles on the lateral regions thereof. The sealing profiles can be made of synthetic material. Preferably, the respective sealing profile has a certain elastic flexibility in order to achieve secure abutment and low-wear sliding along the respective side shield arrangement. The respective sealing profile cooperates with the associated side shield arrangement during a displacement move of the roof part in that the sealing profile presses onto corresponding side surfaces of the shield blade from above and, thus, causes pivoting of the shield blade.

Further advantages and features of the invention will become apparent from the claims and from the description below of a preferred exemplary embodiment, illustrated with reference to the drawings.

### BRIEF DESCRIPTION OF THE DRAWINGS

FIG. 1 shows in a perspective view an embodiment of a roof system according to the invention in the closed condition;

FIG. 2 shows in an enlarged perspective view a detail of the roof system according to FIG. 1 with a movable roof part of the roof system omitted;

FIG. 3 shows in another enlarged perspective view a detail of the illustration according to FIG. 2 in the region of a left-hand—as seen in the ordinary driving direction—side shield arrangement;

FIG. 4 shows in another perspective view obliquely from inside a detail of the side shield arrangement according to FIG. 3 in the region of a rear bearing point;

FIG. 5 shows in a further enlarged, perspective view a region of a front bearing point of the side shield arrangement according to FIG. 4;

FIG. 6 shows a schematic cross-sectional view of the roof system according to FIGS. 1 to 5 in the region of cooperation of the movable roof part with the side shield arrangement; and

FIG. 7 shows an illustration of the roof system according to FIGS. 1 to 5 similar to FIG. 6 in the region of a rear bearing point of the side shield arrangement.

### DETAILED DESCRIPTION

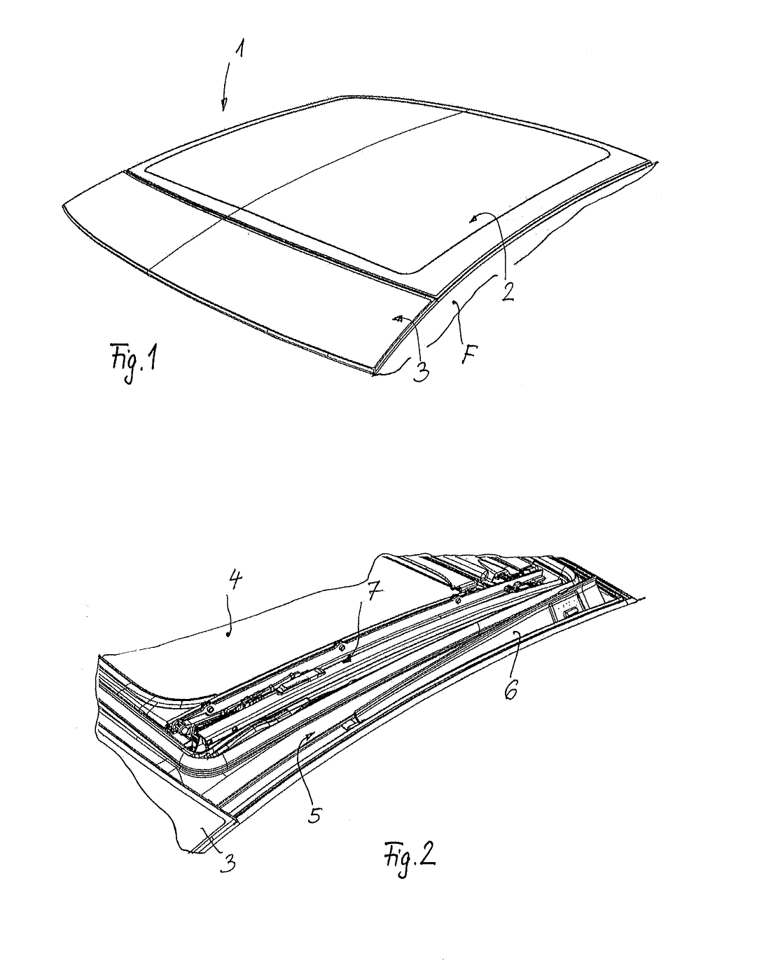

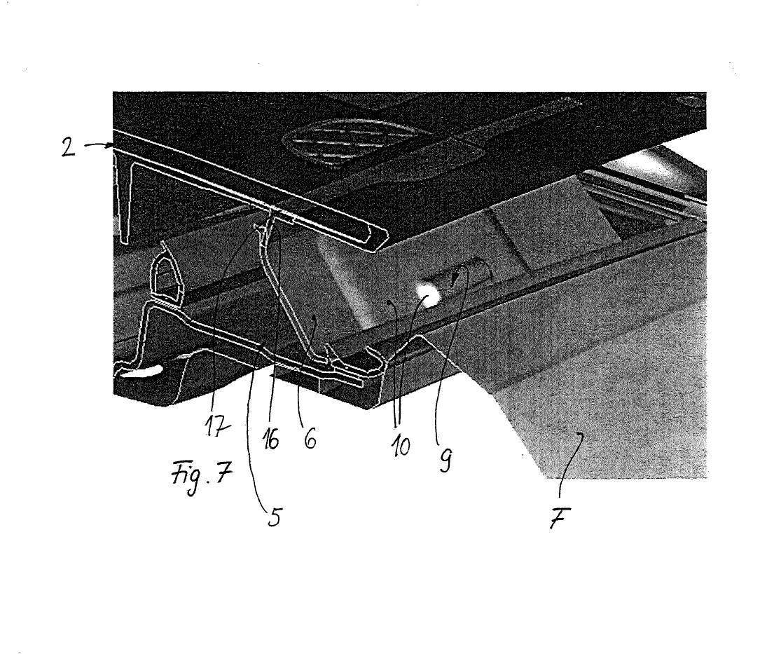

An automotive passenger vehicle includes a vehicle roof F which is provided with a roof system 1 according to FIGS. 1 to 7. The roof system 1 comprises a supporting frame 5 fixedly connected to corresponding roof bodywork components of the vehicle roof F in the assembled condition. The supporting frame 5 encloses a roof opening portion 4 which offers an opening towards a vehicle interior of the passenger vehicle. Towards the front, as seen in the ordinary driving direction, the supporting frame 5 is associated with a front shield 3 which covers a front region of the supporting frame 5 and adjoins an upper section of a wind shield panel frame of the passenger vehicle. The roof opening portion 4 is closable or exposable by a cover-shaped, movable roof part 2. The movable roof part 2 is guided on a respective opposite lateral region of the supporting frame 5 for displacement between a closed position (FIG. 1) and at least one open position (FIGS. 6 and 7) using a guiding mechanism 7. Thereby, the roof part 2 is initially transferable from a closed position to a ventilation position, wherein the roof part 2 is deployed obliquely upwards and rearwards. In the open position, the roof part 2 is deployed upwards by means of the two guiding mechanisms 7 on the opposite longitudinal sides of the supporting frame 5 backwards, passing a rear-sided, stationary roof zone, and displaced towards a rear side of the roof system 1.

In order to achieve sight protection and noise protection both in the ventilation position of the roof part 2 and also in the open position of the roof part 2, the supporting frame 5 is associated with a corresponding side shield arrangement on each of both sides of the roof opening portion 4. The opposite side shield arrangements are disposed mirror-symmetrical to a vertical vehicle central longitudinal plane, however, for the rest have an identical design and mounting. Merely the left hand-sided side shield arrangement, as seen in the driving direction, will be described in more detail below. The explanations apply similarly to the opposite, right hand-sided side shield arrangement.

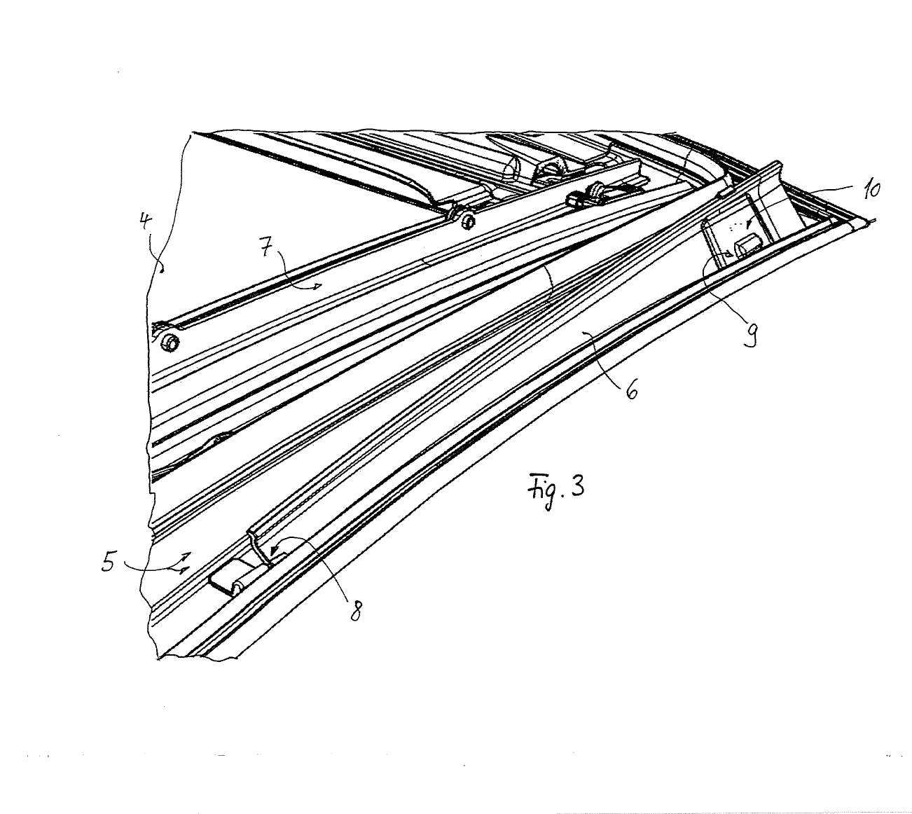

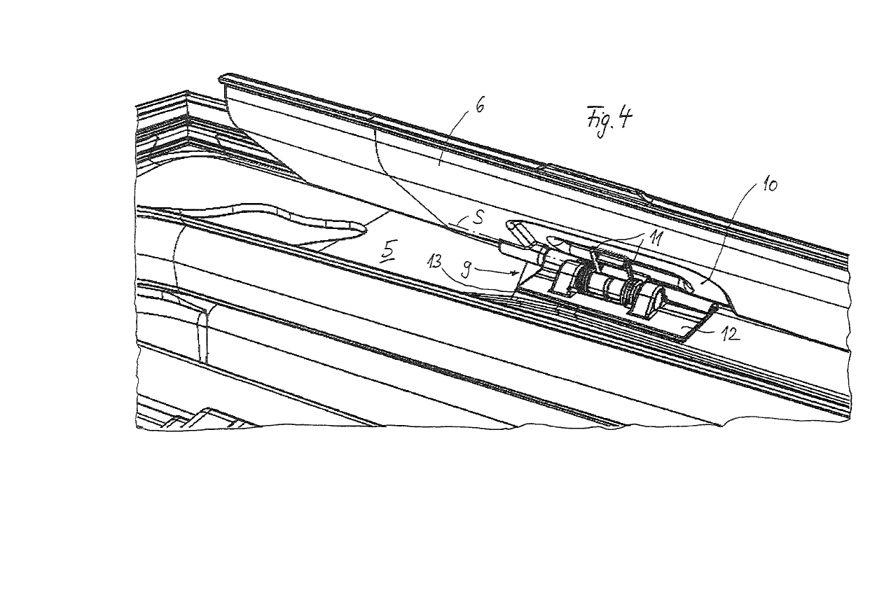

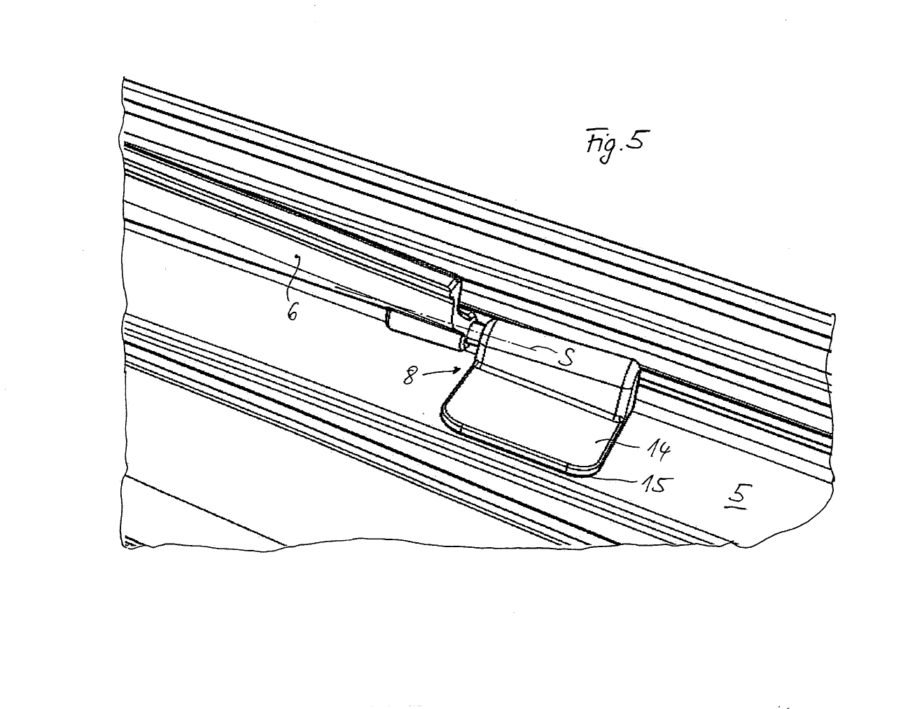

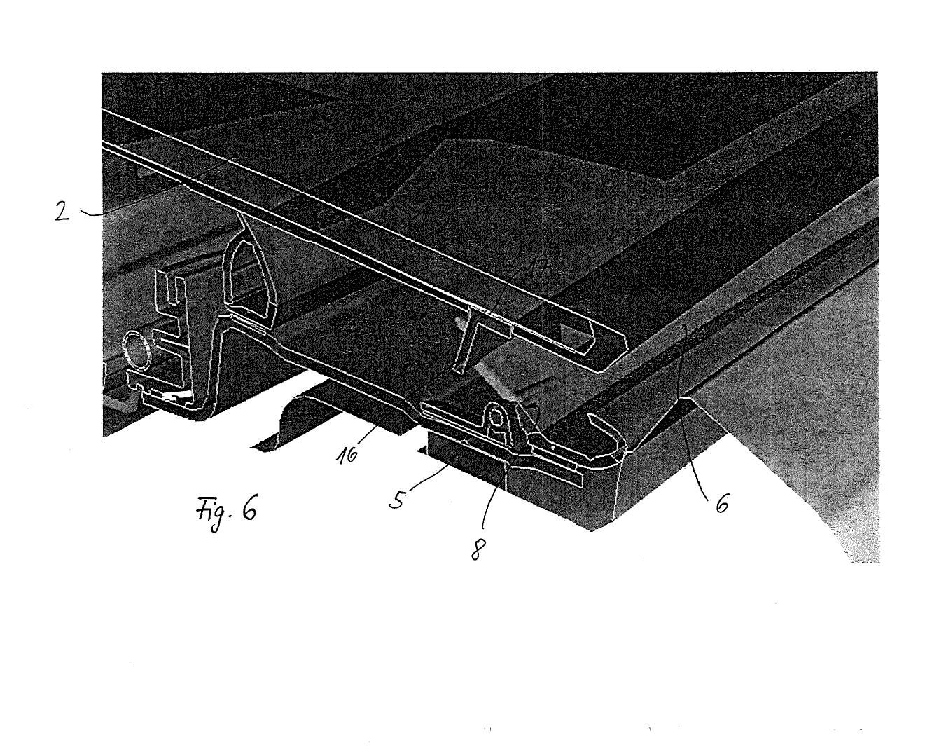

The side shield arrangement includes a one-piece shield blade 6 which is at least largely dimensionally stable and produced from a synthetic material or a light metal alloy. The shield blade 6 has an essentially trapezoid base area, wherein the shield blade 6 has a gradually increasing height from the front towards the back—related to its deployed functional condition. The shield blade 6 is pivotably mounted in the region of a front bearing point 8 and in the region of a rear bearing point 9. The front bearing point 8 and the rear bearing point 9 define a common pivot axis extending in the longitudinal direction of the supporting frame 5. The pivot axis extends at least largely along the vehicle longitudinal direction. The front bearing point 8 is provided on a face end of the shield blade 6 of the side shield arrangement, as readily apparent from FIGS. 3 and 5. For that purpose, a pivot bearing pin (not illustrated in more detail) extends coaxially to the pivot axis from a front face end region of the shield blade 6 towards the front. Said pivot bearing pin is received in a bearing flange of the bearing point 8, which flange constitutes a roof-fixed bearing section of the front bearing point 8. The bearing flange includes a seating plate 14 which is fixed to a supporting surface of the supporting frame 5 over the area using an adhesive layer 15. The common pivot axis S is indicated in FIGS. 4 and 5.

The rear bearing point 9 includes a bearing flange 12 held fixed to the roof, which flange is pivotably connected to a pin seat provided on the shield blade 6 by means of a not visible pivot bearing pin coaxial to the pivot axis S. The bearing flange 12, also referred to as bearing section, includes a planar bottom plate which is connected to the supporting surface of the supporting frame 5 over the area using an adhesive layer 13. Furthermore, a spring device comprising a leg spring 11 is arranged on the bearing flange 12. The leg spring 11 is readily apparent with reference to FIG. 4 and is held on the bearing flange 12 by means of a bearing device not illustrated in more detail. The bearing device of the spring device, holding the leg spring 11, includes a rotational axis for the leg spring 11 oriented in parallel to the pivot axis S. A bracket leg of the leg spring 11 is supported on the shield blade 6 of the side shield arrangement from an inner side. The shield blade 6 is provided with a reinforcement 10 in the region of the rear bearing point 9, which reinforcement is formed as an integrally shaped bulge. The bulge is achieved by corresponding profiling of the shield blade 6. The bracket leg of the leg spring 11 is supported on the shield blade 6 on the inner side in the region of the reinforcement 10. The leg spring 11 exerts a permanent torque on the shield blade 6 in the direction towards the upwards deployed functional position thereof. The reinforcement 10, designed as a bulge, is additionally provided with a bulging section in the vicinity of the bearing device for the leg spring 11. The bulging section is readily apparent with reference to FIG. 3 and with reference to FIG. 7. The bearing device of the leg spring 11 plunges into said bulging section, when the shield blade 6 is located in its downwards urged rest position. Consequently, the bulging section prevents the shield blade 6 from impacting onto an outer contour of the bearing device for the leg spring 11 during inwards and downwards pivoting in the direction towards the rest position, before the shield blade 6 has reached its rest position.

It is apparent with reference to FIGS. 6 and 7 that the shield blade 6 of the side shield arrangement is supported on a sealing profile 16 of the movable roof part 2 due to the permanent spring tension by the leg spring from below and from the inside. The sealing profile 16 has an L-shaped cross section and is fixed to a bottom side of the movable roof part 2 by a holding section 17. A support leg of the sealing profile 16 protrudes from the bottom side of the movable roof part 2 downwards. The sealing profile 16 is at least largely dimensionally stable and is preferably made of a synthetic material, preferably including an elastomer component. The sealing profile 16 exhibits a rigidity high enough that sufficiently high pressure can be applied to the outer side of the shield blade 6 of the side shield arrangement to compensate the deployment force of the leg spring 11.

It is apparent with reference to FIGS. 3 to 5 that an upper longitudinal edge zone of the shield blade 6 of the side shield arrangement has an S-shaped or C-shaped curvature as seen in a cross-sectional view. As a result, an improved abutment and support function between the sealing profile 16 of the roof part 2 and the shield blade 6 is obtained while the roof part 2 is displaced in the direction towards its open position or in the direction towards its closed position. Thereby, a particularly good, essentially linear abutment of the shield blade 6 in the region of a bottom side of the at least to a limited extent elastically flexible sealing profile 16 of the movable roof part 2 is achievable. Upon transferring the movable roof part 2 towards its closed position, the roof profile 16 urges the shield blade 6 of the side shield arrangement into its lower rest position. Once the movable roof part 2 is raised to its ventilation position and/or moved to its open position, the shield blade 6 deploys upwards at least partially owing to the spring pre-tensioning, wherein the degree of pivoting and deployment of the shield blade upwards is depending on the support of the shield blade 6 by the sealing profile 16.

1. Side shield arrangement for an openable roof system of an automotive vehicle, comprising a shield blade which is mounted to be pivotable between a lowered rest position and a deployed functional position, which has two bearing points spaced from each other in the longitudinal direction of the shield blade, and which has force applied by a spring device towards the direction of the deployed functional position, wherein a front bearing point is disposed on the face end of the shield blade, and in that a rear bearing point is provided with the spring device.

2. Side shield arrangement according to claim 1, wherein the shield blade is provided with a reinforcement in the region of the rear bearing point.

3. Side shield arrangement according to claim 1, wherein both the front and the rear bearing points have a roof-fixed bearing section, each thereof adhesively bonded to a supporting surface of the roof system in the ready-for-use assembled condition.

4. Side shield arrangement according to claim 1, wherein the spring device includes a leg spring which is supported on the shield blade in the region of the reinforcement.

5. Openable roof system of an automotive vehicle, comprising a roof part displaceable between a closed position and an open position, and comprising at least one side shield arrangement according to claim 1, wherein the roof part includes at least one sealing profile in the region of a bottom side, which sealing profile cooperates with the side shield arrangement during an opening or closing move of the roof part.
